(19) United States
(12) Patent Application Publication
(10) Pub. No.: US 2025/0074646 A1
(43) Pub. Date: Mar. 6, 2025

(54) METHOD OF PACKAGING NICOTINE POUCH AND NICOTINE POUCH MANUFACTURED USING THE SAME

(71) Applicant: KT&G CORPORATION, Daejeon (KR)

(72) Inventors: Eun Mi JEOUNG, Daejeon (KR); Sung Jong KI, Daejeon (KR); Sung Je CHA, Daejeon (KR); Jun Won SHIN, Daejeon (KR)

(73) Assignee: KT&G CORPORATION, Daejeon (KR)

(21) Appl. No.: 18/819,258

(22) Filed: Aug. 29, 2024

(30) Foreign Application Priority Data
Aug. 31, 2023 (KR) 10-2023-0115701

(51) Int. Cl. B65B 51/26; A24F 23/02

(52) U.S. Cl. CPC B65B 51/26; A24F 23/02

(57) ABSTRACT

A method of packaging a nicotine pouch by forming a longitudinal seal and a cross seal of a packaging material is provided. The packaging material may include pulp and a thermoplastic resin fiber, the longitudinal seal and the cross seal may have a width of 2 millimeters (mm) to 5 mm, and a scaling temperature at which the longitudinal seal and the cross seal are formed may range from 110° C. to 160° C.

### CROSS-REFERENCE TO RELATED APPLICATION

This application claims the benefit of Korean Patent Application No. 10-2023-0115701, Aug. 31, 2023, in the Korean Intellectual Property Office, the entire disclosure of which is incorporated herein by reference for all purposes.

### BACKGROUND

### 1. Field of the Invention

One or more embodiments relate to a method of packaging a nicotine pouch, and a nicotine pouch manufactured using the same.

### 2. Description of the Related Art

Nicotine pouches are one of types of smoking articles and include inner filling materials and outer packaging materials for packaging. A nicotine pouch is used inside the mouth of a user to transfer nicotine into a body of the user. Generally, a user puts a nicotine pouch between a lip and an upper gum or a lower gum and leaves the nicotine pouch for a limited period of time, to use the nicotine pouch.

Therefore, the nicotine pouch requires a predetermined hardness together with a flexibility to minimize a foreign body sensation caused while the user is using the nicotine pouch, and a sealing portion requires a sufficient strength to prevent a leakage of an inner filling material during the manufacturing, transportation, and use of the nicotine pouch.

In general, a nicotine pouch is formed of a nonwoven material and manufactured by packaging a predetermined amount of nicotine powder using a three-sided seal packaging method or a back-sided seal packaging method, which is a common powder packaging method, using a heat sealing device or an ultrasonic sealing device.

When the heat sealing device is used, sealing is generally performed at a temperature of 100 to 300° C. using a packaging material including a thermoplastic fiber or a packaging material including a binder.

Here, according to a seal width and a sealing method, inner powder may leak out during the transportation and use of the nicotine pouch by a consumer after packaging of the nicotine pouch, and a foreign body sensation in the mouth may be felt due to the sealing portion.

Therefore, there is a desire for a method of packaging a nicotine pouch using an appropriate seal width and sealing method to provide a sufficient seal strength while preventing a foreign body sensation in the mouth.

### SUMMARY

One or more embodiments provide a method of packaging a nicotine pouch that may prevent a leakage of an inner filler through a sealing portion during a manufacturing, transportation, and use of the nicotine pouch and prevent a user from feeling a foreign body sensation inside his or her mouth.

However, goals to be achieved are not limited to those described above, and other goals not mentioned above can be clearly understood by one of ordinary skill in the art from the following description.

According to an embodiment, there is provided a method of packaging a nicotine pouch by forming a longitudinal seal and a cross seal of a packaging material, wherein the packaging material includes pulp and a thermoplastic resin fiber, the longitudinal seal and the cross seal have a width of 2 millimeters (mm) to 5 mm, and a sealing temperature at which the longitudinal seal and the cross seal are formed ranges from 110° C. to 160° C.

The pulp may include soft pulp, and the thermoplastic resin fiber may include polypropylene (PP)/polyethylene (PE).

The packaging material may include 50 to 80% by weight (wt %) of soft pulp, and 20 to 50 wt % of PP/PE.

The packaging material may include 55 to 65 wt % of soft pulp, and 35 to 45 wt % of PP/PE.

The longitudinal seal may be sealed by a lap seal method.

The longitudinal seal and the cross seal may have a width of 2 mm to 3 mm, and the sealing temperature at which the longitudinal seal and the cross seal are formed may range from 140° C. to 160° C.

The longitudinal seal and the cross seal may have a width of 5 mm, and the sealing temperature at which the longitudinal seal and the cross seal are formed may range from 110° C. to 130° C.

The longitudinal seal and the cross seal may have a seal strength of 0.2 newtons per millimeter (N/mm) or greater.

According to another aspect, there is provided a nicotine pouch manufactured by the method described above.

Additional aspects of embodiments will be set forth in part in the description which follows and, in part, will be apparent from the description, or may be learned by practice of the disclosure.

According to embodiments, a method of packaging a nicotine pouch may prevent a leakage of powder during a manufacturing, transportation, and use of the nicotine pouch by adjusting a width and a sealing temperature of a seal, and may minimize a foreign body sensation that a user may feel through a sealing portion during the use of the nicotine pouch.

It should understood that the effects of the present disclosure are not limited to the above-described effects, but are construed as including all effects that can be inferred from the configurations and features described in the following description or claims of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a method of packaging a nicotine pouch;

FIG. 2 illustrates a longitudinal seal and a cross seal of a nicotine pouch; and

FIG. 3 illustrates results of a comparison of a seal shape and a seal strength between a lap seal method and a fin seal method.

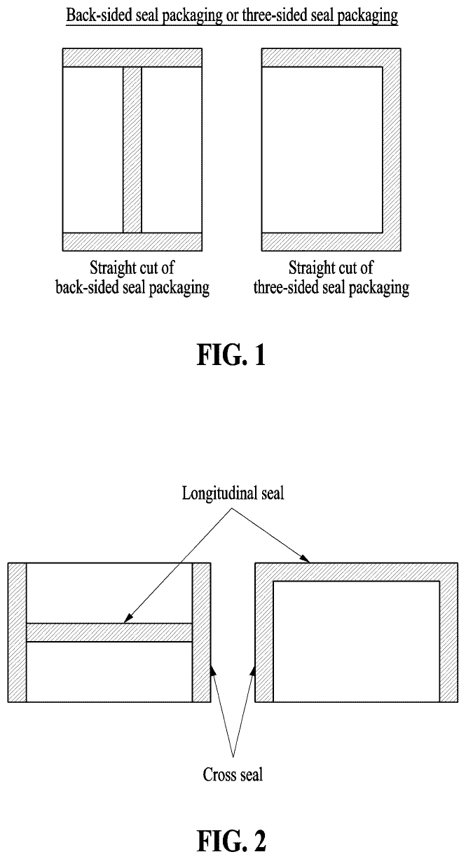

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

According to an embodiment, a method of packaging a nicotine pouch by forming a longitudinal seal and a cross seal of a packaging material may be provided. The packaging material may include pulp, and a thermoplastic resin fiber. The longitudinal seal and the cross seal may have a width of 2 millimeters (mm) to 5 mm, and a sealing temperature at which the longitudinal seal and the cross seal are formed may range from 110° C. to 160° C.

If the width of the longitudinal seal and the cross seal exceeds the above range, a user may feel a foreign body sensation while using the nicotine pouch in his or her mouth. If the width is extremely small, a seal strength may decrease, and an inner filler may leak out.

In addition, if the sealing temperature exceeds the above range, surface hardening and discoloration may occur. If the sealing temperature is below the above range, the inner filler may leak out due to a failure to ensure a sufficient seal strength.

Since a sealing area changes depending on a seal width of a pouch, a sealing temperature required to ensure a sealing characteristic may vary, and different phenomena may occur according to a change in the sealing temperature. Specifically, a foreign body sensation felt by a user during use of a nicotine pouch may be minimized as the seal width decreases, however, the risk of bursting of a sealing portion may be present due to a failure to form a sufficient seal strength. The seal strength may increase as the sealing temperature increases, however, a quality may decrease due to surface hardening and discoloration. Therefore, there is a desire for an optimization of the seal width and the sealing temperature based on the seal width.

Thus, desirably, the longitudinal seal and the cross seal may have a width of 2 mm to 3 mm, and the sealing temperature at which the longitudinal seal and the cross seal are formed may range from 140° C. to 160° C.

In addition, desirably, the longitudinal seal and the cross seal may have a width of 5 mm, and the sealing temperature at which the longitudinal seal and the cross seal are formed may range from 110° C. to 130° C.

In an example of the width of 2 mm to 3 mm, if the sealing temperature is below the lower limit, a possibility of a leakage of the inner filler through the sealing portion due to a failure to ensure a sufficient seal strength may be present, and if the sealing temperature exceeds the upper limit, the risk of surface hardening and discoloration may be present.

In another example of the width of 5 mm, an area of the sealing portion may increase, in comparison to the width of 2 mm to 3 mm. Accordingly, a seal strength sufficient to manufacture a pouch may be achieved even when sealing is performed at a relatively low temperature.

According to an embodiment, the pulp may include at least one of soft pulp, viscose, lyocell, ramie, flax, and bamboo fibers. Desirably, the pulp may include soft pulp.

According to an embodiment, the thermoplastic resin fiber may include at least one of polypropylene (PP), polyethylene (PE), PP/PE, and polyethylene terephthalate (PET). Desirably, the thermoplastic resin fiber may include PP/PE.

When the soft pulp is used as pulp and when the PP/PE is used as a thermoplastic resin fiber, as described above, manufacturing of a nonwoven satisfying physical specifications as a nicotine pouch packaging material using a wet-laid method may be possible.

According to an embodiment, the packaging material may include 50 to 80% by weight (wt %) of soft pulp, and 20 to 50 wt % of PP/PE, may desirably include 55 to 65 wt % of soft pulp, and 35 to 45 wt % of PP/PE, and may more desirably include 60 wt % of soft pulp, and 40 wt % of PP/PE.

If the amount of the PP/PE is less than the lower limit, the nicotine pouch may burst due to an insufficient seal strength of the nicotine pouch. If the amount of the PP/PE exceeds the upper limit, a web of the packaging material may not be properly formed, and it may be impossible to satisfy physical characteristics, such as a tensile rate or a tensile strength for packaging, and accordingly, the packaging material may be unsuitable to be used as a packaging material for the nicotine pouch.

According to an embodiment, the longitudinal seal may be sealed by a lap seal method.

The longitudinal seal, which is a portion in a direct contact with an inner lip and a gum, may be the most important factor in determining a degree of a foreign body sensation when a consumer uses a product. The longitudinal seal may be formed using a lap seal method or a fin seal method.

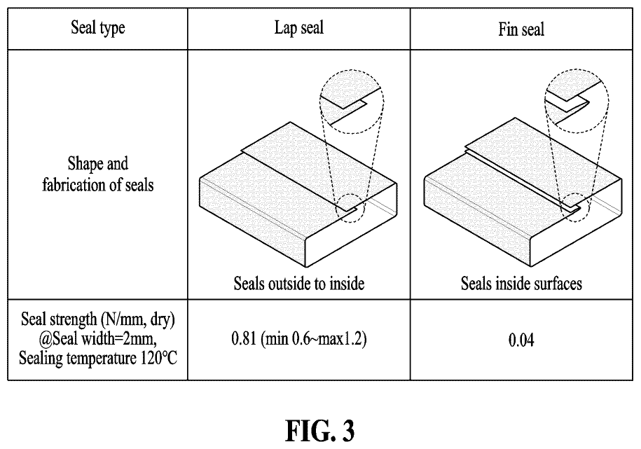

As shown in FIG. 3, the lap seal method may be a method of performing sealing such that an inner face of one end of a packaging material contacts an outer face of another end of the packaging material, and the fin seal method may be a method of performing sealing such that inner faces of both ends of a packaging material contact. In terms of a usability and a seal strength, the lap seal method may be superior to the fin seal method.

Referring to FIG. 3, it may be confirmed that the lap seal method exhibits a high seal strength in comparison to the fin seal method at the same seal width and the same sealing temperature.

According to an embodiment, the longitudinal seal and the cross seal may have a seal strength of 0.2 newtons per millimeter (N/mm) or greater.

To prevent a leakage of the inner filler through the sealing portion during a manufacturing, transportation, and use of a pouch, a sufficient seal strength, at least a seal strength of 0.2 N/mm, may be required for the sealing portion.

According to an embodiment, a nicotine pouch manufactured by the method of packaging the nicotine pouch described above.

A nicotine pouch, which is one of types of smoking articles, may include an inner filling material, and an outer packaging material for packaging. The inner filling material may include, for example, nicotine, a pH adjuster, a binder, a flavoring, and the like. A nicotine pouch may be manufactured by packaging the inner filling material according to an embodiment.

Hereinafter, the present disclosure will be described in more detail based on examples. The following examples are described for the purpose of illustrating the present disclosure, and are not intended to limit the scope of the present disclosure.

### <Experimental Example 1> Determination of Optimal Sealing Temperature at Seal Width of 2 mm

To determine the optimal sealing temperature according to the seal width, a packaging material was sealed by adjusting the seal width to 2 mm and adjusting the sealing temperature to 120° C., 150° C., 180° C., and 210° C., using a heat sealing device, a seal strength was measured, and whether surface hardening or discoloration has occurred was determined.

The seal strength was measured using an average value of ten samples based on a CRM No. 90 test condition, and information on used nonwoven samples is shown in Table 1 below.

TABLE 1

| | | Basis | | Tensile | |
|---|---|---|---|---|---|
| | Composition | weight | Thickness | strength | Elongation |
| Manufacturer | of Fiber | (g/m²) | (μm) | (N/mm) | (%) |
| Domestic | Soft pulp (60%) + | 26.5 | 95.0 | 1.28 | 2.8 |
| manufacturing | PP/PE (40%) | | | | |

The measured seal strength and information on whether a surface has changed are shown in Table 2 below.

TABLE 2

| Sealing temperature (° C.) | 120 | 150 | 180 | 210 |
|---|---|---|---|---|
| Seal strength (N/mm, dry) | 0.04 ± 0.02 | 0.27 ± 0.02 | 0.34 ± 0.03 | 0.39 ± 0.03 |
| Whether surface has changed | X | X | O | O |

Referring to Table 2, it may be confirmed that at the seal width of 2 mm, a sufficient seal strength was achieved at 150° C. or greater, but the surface hardening or discoloration occurred at 180° C. or greater.

### <Experimental Example 2> Determination of Optimal Sealing Temperature at Seal Width of 3 mm

To determine the optimal sealing temperature according to the seal width, the seal strength was measured and whether surface hardening or discoloration has occurred was determined in the same manner as in Experimental Example 1, except that the seal width was 3 mm.

The measured seal strength and information on whether a surface has occurred are shown in Table 3 below.

TABLE 3

| Sealing temperature (° C.) | 120 | 150 | 180 | 210 |
|---|---|---|---|---|
| Seal strength (N/mm, dry) | 0.18 ± 0.02 | 0.22 ± 0.02 | 0.26 ± 0.03 | 0.33 ± 0.03 |
| Whether surface has occurred | X | X | O | O |

Referring to Table 3, similarly to the seal width of 2 mm, it may be confirmed that a sufficient seal strength was achieved at 150° C. or greater. However, in Experimental Example 2, surface hardening and discoloration also occurred at 180° C. or greater.

### <Experimental Example 3> Determination of Optimal Sealing Temperature at Seal Width of 5 mm

To determine the optimal sealing temperature according to the seal width, the seal strength was measured and whether surface hardening or discoloration has occurred was determined in the same manner as in Experimental Example 1, except that the seal width was 5 mm.

TABLE 4

| Sealing temperature (° C.) | 120 | 150 | 180 | 210 |
|---|---|---|---|---|
| Seal strength (N/mm, dry) | 0.26 ± 0.02 | 0.26 ± 0.02 | 0.26 ± 0.03 | 0.35 ± 0.03 |
| Whether surface has changed | X | X | O | O |

Referring to Table 4, it may be found that at the seal width of 5 mm, a sufficient seal strength was achieved even at 120° C., and it may be confirmed that surface hardening and discoloration occurred at 180° C. or greater.

Based on the results of Experimental Examples 1 to 3, it may be found that 150° C., at which a sufficient seal strength may be achieved while preventing an occurrence of surface hardening or discoloration, is the most desirable sealing temperature at the seal width of 2 to 3 mm, and that 120° C., the lowest temperature, at which a sufficient seal strength may be achieved while preventing an occurrence of surface hardening or discoloration, is the most desirable sealing temperature at the seal width of 5 mm.

While the embodiments are described with reference to the drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of packaging a nicotine pouch by forming a longitudinal seal and a cross seal of a packaging material, the method comprising:
wherein the packaging material comprises pulp, and a thermoplastic resin fiber,
the longitudinal seal and the cross seal have a width of 2 millimeters (mm) to 5 mm, and
a sealing temperature at which the longitudinal seal and the cross seal are formed ranges from 110° C. to 160° C.

2. The method of claim 1, wherein
the pulp comprises soft pulp, and
the thermoplastic resin fiber comprises polypropylene (PP)/polyethylene (PE).

3. The method of claim 1, wherein the packaging material comprises 50 to 80% by weight (wt %) of soft pulp, and 20 to 50 wt % of PP/PE.

4. The method of claim 1, wherein the packaging material comprises 55 to 65 wt % of soft pulp, and 35 to 45 wt % of PP/PE.

5. The method of claim 1, wherein the longitudinal seal is sealed by a lap seal method.

6. The method of claim 1, wherein
the longitudinal seal and the cross seal have a width of 2 mm to 3 mm, and
the sealing temperature at which the longitudinal seal and the cross seal are formed ranges from 140° C. to 160° C.

7. The method of claim 1, wherein
the longitudinal seal and the cross seal have a width of 5 mm, and
the sealing temperature at which the longitudinal seal and the cross seal are formed ranges from 110° C. to 130° C.

8. The method of claim 1, wherein the longitudinal seal and the cross seal have a seal strength of 0.2 newtons per millimeter (N/mm) or greater.

9. A nicotine pouch manufactured by the method of packaging a nicotine pouch of claim 1.
